(19) United States
(12) Patent Application Publication
(10) Pub. No.: US 2014/0172844 A1
(43) Pub. Date: Jun. 19, 2014

(54) System and Method For Generating Student Activity Maps in A University

(71) Applicant: SRM INSTITUTE OF SCIENCE AND TECHNOLOGY, WEST MAMBALAM (IN)

(72) Inventor: SRIDHAR VARADARAJAN, BANGALORE (IN)

(73) Assignee: SRM INSTITUTE OF SCIENCE AND TECHNOLOGY, WEST MAMBALAM (IN)

(21) Appl. No.: 13/890,452

(22) Filed: May 9, 2013

(30) Foreign Application Priority Data
Dec. 14, 2012 (IN) 5229CHE2012

(51) Int. Cl. G06F 17/30

(52) U.S. Cl. CPC G06F 17/30551
USPC 707/725

(57) ABSTRACT

An educational institution (also referred as a university) is structurally modeled using a university model graph. A key benefit of modeling of the educational institution is to help in an introspective analysis by the educational institute. In order to build an effective university model graph, it is required to gather and analyze the various activities performed on the university campus by the various entities of the university. A system and method for automated generation of activity maps involves analysis of multiple student specific activity flows (activities), and aggregating and abstracting them to generate a variety of student-specific activity maps. These activity maps play a role in the student counseling process.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” with an application number 1809/CHE/2010 and filing date of 28 Jun., 2010.

3. A reference is made to yet another of the applicants' earlier Indian patent application titled “System and Method for University Model Graph based Visualization” with the application number 1848/CHE/2010 dated 30 Jun. 2010.

4. A reference is made to yet another of the applicants' earlier Indian patent application titled “System and method for what-if analysis of a university based on university model graph” with the application number 3203/CHE/2010 dated 28 Oct. 2010.

5. A reference is made to yet another of the applicants' earlier Indian patent application titled “System and method for comparing universities based on their university model graphs” with the application number 3492/CHE/2010 dated 22 Nov. 2010.

6. A reference is made to the applicant's copyright document titled “Activity and Interaction based Holistic Student Modeling in a University: ARIEL UNIVERSITY STUDENT Process Document” that is being forwarded under The Registrar of Copyright, Copyright Office, New Delhi.

7. A reference is made to yet another of the applicants' earlier Indian patent application titled “System and Method for Student Activity Gathering in a University” with the application number 3905/CHE/2011 dated 14 Nov. 2011.

8. A reference is made to yet another of the applicants' earlier Indian patent application titled “System and method for generating student activity flows in a university” with the application number 4157/CHE/2011 dated 30 Nov. 2011.

### FIELD OF THE INVENTION

The present invention relates to the analysis of the information about a university in general, and more particularly, the analysis of the activities of the university associated with structural representations. Still more particularly, the present invention relates to a system and method for automatic generation of activity maps based on the activity flows (activities) associated with the university.

### BACKGROUND OF THE INVENTION

An Educational Institution (EI) (also referred as University) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. The educational institutions are positioned in a very competitive environment and it is a constant endeavor of the management of the educational institution to ensure to be ahead of the competition. This calls for a critical analysis of the overall functioning of the university and help suggest improvements so as enhance the overall strength aspects and overcome the weaknesses. Consider a typical scenario of assessing of a student of the Educational Institution. In order to achieve a better holistic assessment, it is required to counsel the student not only based on the curricular activities but also those other but related activities. This requires the generation of the activity maps based on the activity flows (activities) associated with a student and to use them appropriately in the holistic assessment and counseling process. Note that the activity maps are somewhat close to student workflows related to the student activities on a campus. In other words, the different kinds of derived activity maps provide much insight into the student workflows.

### DESCRIPTION OF RELATED ART

U.S. Pat. No. 8,103,536 to Green; David G. (Kirkland, Wash.), Mehta; Bimal K. (Sammamish, Wash.), Thane; Satish R. (Redmond, Wash.), Shukla; Dharma K. (Sammamish, Wash.), Parasnis; Abhay Vinayak (Sammamish, Wash.) for Unified model for authoring and executing flow-based and constraint-based workflows” (issued on Jan. 24, 2012 and assigned to Microsoft Corporation (Redmond, Wash.)) describes the designing and executing of a workflow having flow-based and constraint-based regions.

U.S. patent application Ser. No. 12/726,798 titled “Optimizing Workflow Engines” by Saha; Dhrubajyoti; (Nagavarapalya, IN); Sarangi; Smruti Ranjan; (Nagavarapalya, IN) (filed on Mar. 18, 2010 and assigned to International Business Machines Corporation, Armonk, N.Y.) describes techniques for implementing a workflow using the notion of a virtual graph.

“Multi-Scale Maps of Scholarly Activity” by Katy Börner (Research Talk at the Organization for Economic Co-Operation and Development (OECD), Paris, France, (http://www.oecd.org), Apr. 12, 2012) elaborates on the modeling science dynamics using multi-level, mixed-methods, and multi-perspective models.

“Ontology-based Semi-automatic Workflow Composition” by Daniel de Oliveira, Eduardo Ogasawara, Jonas Dias, Fernanda Baião, and Marta Mattoso (appeared in the Journal of Information and Data Management, Vol. 3, No. 1, February 2012, Pages 61-72) describes an approach for coupling a workflow technology to an abstract workflow representation to enable the usage of semantic mechanisms.

“An Algebraic Approach for Data-Centric Scientific Workflows” by Eduardo Ogasawara, Daniel de Oliveira, Patrick Valduriez, Jonas Dias, Fábio Porto, and Marta Mattoso (appeared in the Proceedings of the VLDB '11, Aug. 29-Sep. 3, 2011, Seattle) describes an algebraic approach and a parallel execution model that enable automatic optimization of scientific workflows.

“Minimizing Human Interaction Time in Workflows” by Christian Hiesinger, Daniel Fischer, Stefan Foll, Klaus Herrmann, and Kurt Rothermel (appeared in the Proceedings of ICIW 2011—The Sixth International Conference on Internet and Web Applications and Services, Mar. 20-25, 2011—St. Maarten, The Netherlands Antilles) describes an algorithm that computes a suitable distribution of a workflow in a global network so as to optimize a workflow to increase the usability for humans.

The known systems do not address the issue of student activity maps generation based on the activities of students in the university context. The present invention provides for a system and method for generating of the well-defined activity maps of students based on their activities depicted as activity flows in a university so as to be of assistance in the holistic assessment and counseling of the students.

### SUMMARY OF THE INVENTION

The primary objective of the invention is to generate activity maps based on the activities of a student in the context of a university.

One aspect of the invention is to generate an activity map based on a cluster of activities.

Another aspect of the invention is to generate an activity map based on a cluster of pseudo-continuous activities.

Yet another aspect of the invention is to generate an activity map based on a cluster of meta-activities.

Another aspect of the invention is to generate a temporal map based on year-wise, term-wise, week-wise, or day-wise clusters.

Yet another aspect of the invention is to generate a location map based on location-wise clusters.

Another aspect of the invention is to generate a location map based on meta-location clusters.

Yet another aspect of the invention is to generate a sequence map based on activity sub-sequences.

Another aspect of the invention is to temporal location activity map based on a three-dimensional cluster of activities.

In a preferred embodiment, the present invention provides a method for (refer to FIG. 3)
generating, with at least one processor, an activity map 1 based on said plurality of activities;
making, with at least one processor, said activity map 1 a part of said plurality of activity maps;
generating, with at least one processor, an activity map 2 based on said plurality of activities;
making, with at least one processor, said activity map 2 a part of said plurality of activity maps;
generating, with at least one processor, an activity map 3 based on said plurality of activities;
making, with at least one processor, said activity map 3 a part of said plurality of activity maps;
generating, with at least one processor, a temporal map 1 based on said plurality of time intervals and said plurality of activities;
making, with at least one processor, said temporal map 1 a part of said plurality of activity maps;
generating, with at least one processor, a location map 1 based on said plurality of locations and said plurality of activities;
making, with at least one processor, said location map 1 a part of said plurality of activity maps;
generating, with at least one processor, a location map 2 based on said plurality of meta-locations and said plurality of activities;
making, with at least one processor, said location map 2 a part of said plurality of activity maps;
generating, with at least one processor, a sequence map 1 based on said plurality of locations and said plurality of activities;
making, with at least one processor, said sequence map 1 a part of said plurality of activity maps;
generating, with at least one processor, a temporal location activity map based on said plurality of locations and said plurality of activities; and
making, with at least one processor, said temporal location activity map a part of said plurality of activity maps.

### BRIEF DESCRIPTION OF THE DRAWINGS

FIG. 1 provides a typical assessment of a university.

FIG. 1A provides a partial list of entities of a university.

FIG. 2 provides a typical list of student-related processes.

FIG. 2A provides a typical list of student-related meta-activities.

FIG. 2B provides a typical list of student locations.

FIG. 2C provides an illustrative list of meta-locations.

FIG. 2D provides a typical list of time intervals.

FIG. 3 depicts the various types of cluster maps.

FIG. 3A provides an illustrative cluster structure and computations.

FIG. 4 provides an illustrative list of activities of a student.

FIG. 5 provides an approach for activity map formation.

FIG. 5A provides an additional approach for activity map formation.

FIG. 6 depicts an approach for temporal map formation.

FIG. 7 depicts an approach for the formation of location map and sequence map.

FIG. 8 provides an approach for temporal location activity map formation.

FIG. 8A provides an illustrative location similarity matrix.

FIG. 9 provides a summary of different kinds of maps.

FIGS. 9A-9H provide different kinds of illustrative maps.

FIG. 9I provides illustrative application scenarios of the different kinds of maps.

### DETAILED DESCRIPTION OF THE PREFERRED EMBODIMENTS

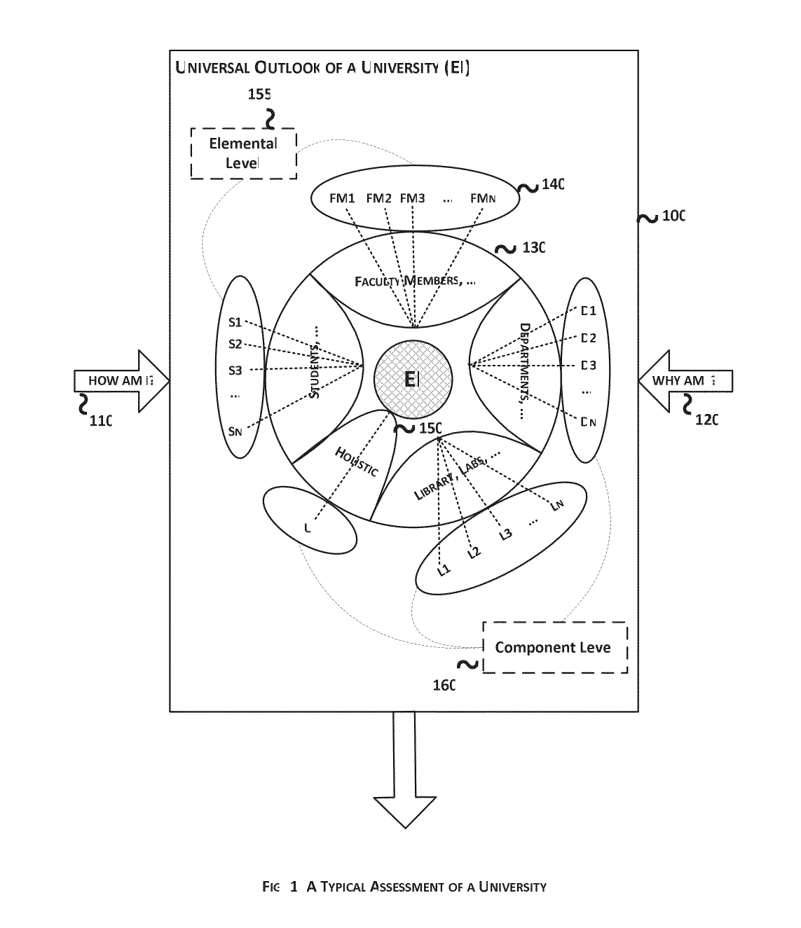

FIG. 1 provides a typical assessment of a university. An Educational Institution (EI) or alternatively, a university, is a complex and dynamic system with multiple entities and each interacting with multiple of other entities. The overall characterization of the EI is based on a graph that depicts these multi-entities multiple relationships. An important utility of such a characterization is to assess the state and status of the EI. What it means is that, in the context of the EI, it is helpful if every of the entities of the EI can be assessed. Assessment of the EI as a whole and the constituents at an appropriate level gives an opportunity to answer the questions such as “How am I?” and “Why am I?”. That is, the assessment of each of the entities and an explanation of the same can be provided. Consider a STUDENT entity: This is one of the important entities of the EI and in any EI there are several instances of this entity that are associated with the students of the EI. The assessment can be at STUDENT level or at S1 (a particular student) level. 100 depicts the so-called “Universal Outlook of a University” and a system that provides such a universal outlook is capable of addressing “How am I?” (110) and “Why am I?” (120) queries. The FACULTY MEMBER entity (130) characterizes the set of all faculty members FM1, FM2, . . . , FMn (140) of the EI. The holistic assessment (150) helps answer How and Why at university level. Observe that there are two distinct kinds of entities: One class of entities is at the so-called “Element” level (155)—this means that this kind of entities is at the atomic level as for as the university domain is concerned. On the other hand, there is a second class of entities at the so-called “Component” level (160) that accounts for remaining entities of the university domain all the way up to the University level. It is essential to determine the various activity maps associated with activities of a student on the university campus in order to achieve a holistic assessment of STUDENT entity.

FIG. 1A depicts a partial list of entities of a university. Note that a deep domain analysis would uncover several more entities and also their relationship with the other entities (180). For example, RESEARCH STUDENT is a STUDENT who is a part of a DEPARTMENT and works with a FACULTY MEMBER in a LABORATORY using some EQUIPMENT, the DEPARTMENT LIBRARY, and the LIBRARY.

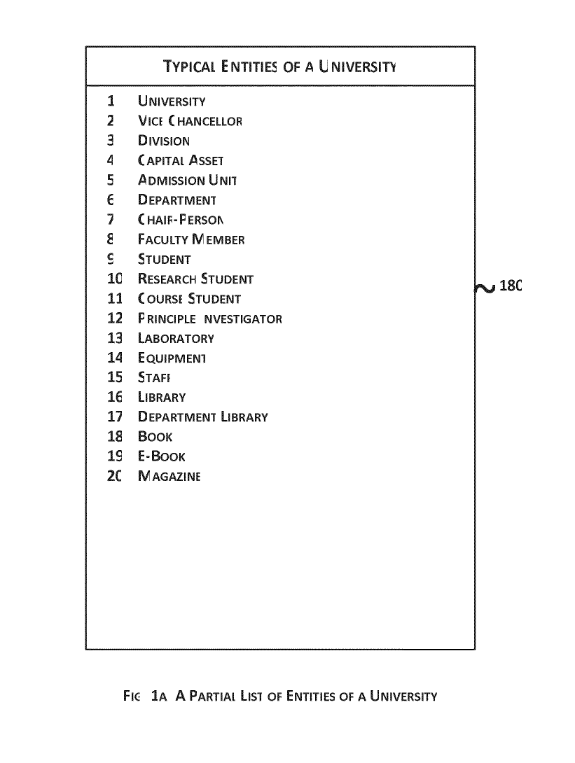

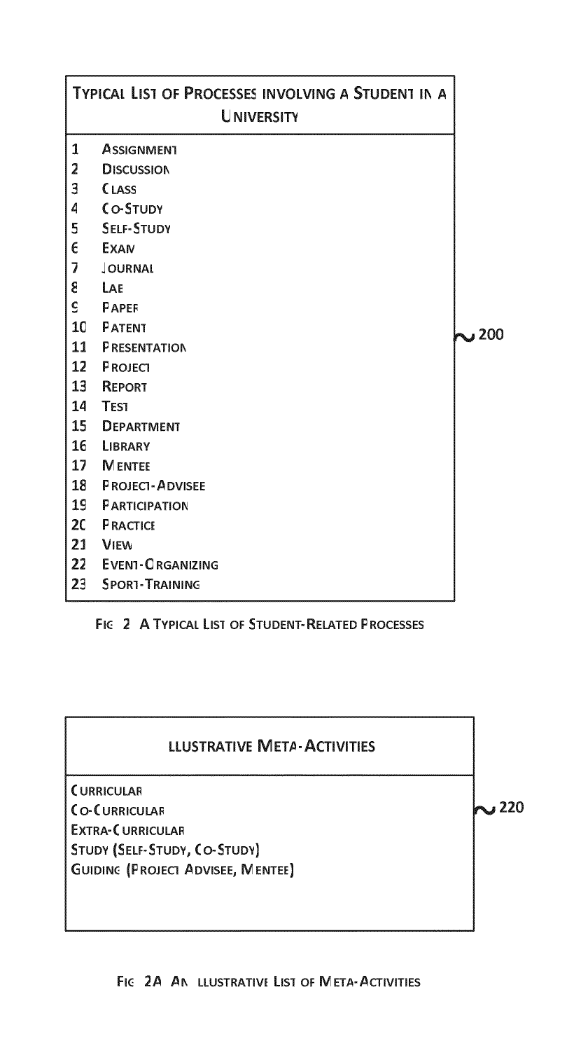

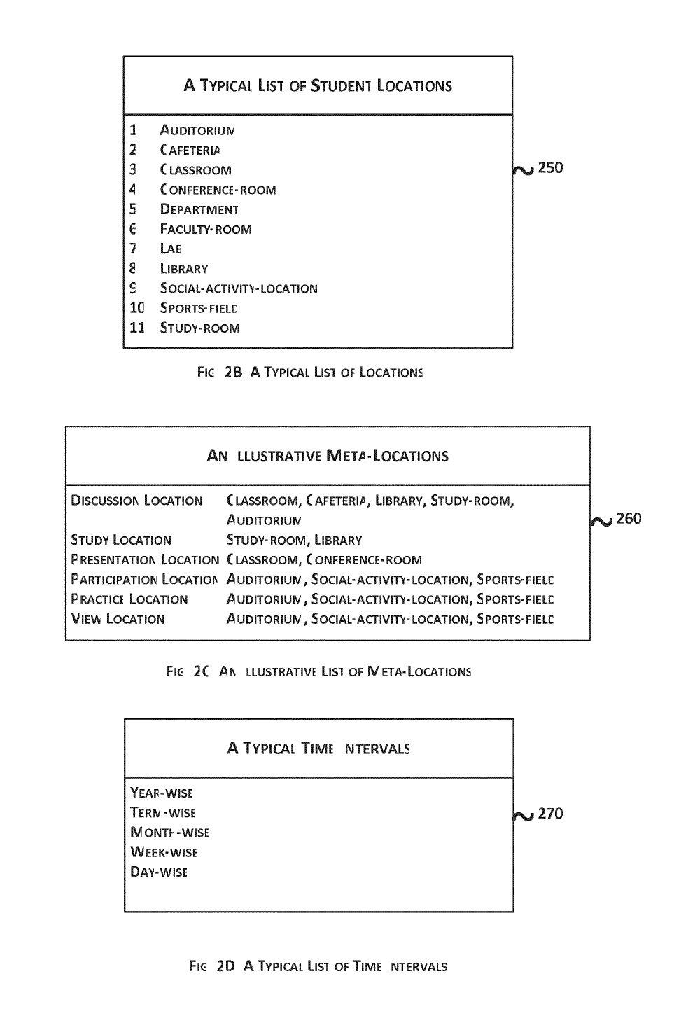

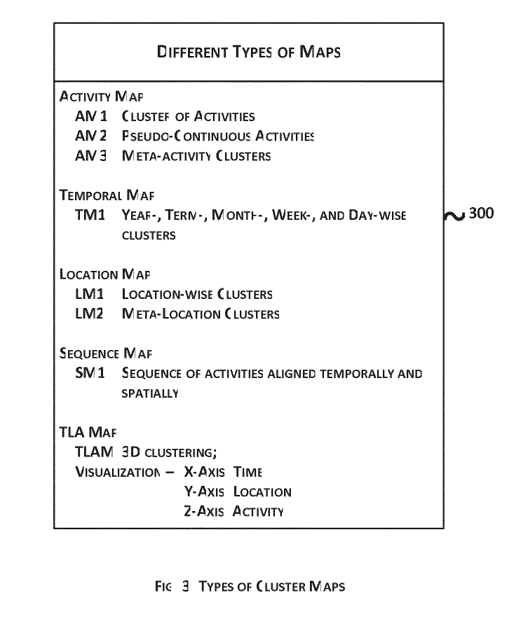

FIG. 2 provides a typical list of student-related processes. This list is arrived at based on the deep domain analysis of a university and is from the point of view of STUDENT entity (200). Specifically, this list categorizes the various activities performed by a typical student within a university. Note that the holistic analysis of a student involves how these activities are performed by the student: for example, a typical behavior of the student in a classroom provides for certain characteristics of the student from the assessment point of view; similarly is the case of the student making a presentation.

FIG. 2A provides a typical list of student-related meta-activities. For example, Curricular, Co-Curricular, Extra-Curricular, Study, and Guiding (220) are an illustrative meta-activities. Meta-activities provide an opportunity to group certain base activities together and play a key role in the map generation process.

FIG. 2B provides a typical list of student locations. The typical list of student locations (250) include (a) Auditorium; (b) Cafeteria; (c) Classroom; (d) Conference-room; (e) Department; (f) Faculty-room; (g) Lab; (h) Library; (i) Social-activity-location; (j) Sports-field; and (k) Study-room.

FIG. 2C provides an illustrative list of meta-locations. Each of the meta-locations defines a possible group of student locations. The list of typical meta-locations include (260) (a) Discussion Location comprising Classroom, Cafeteria, Library, Study-room, Auditorium; (b) Study Location comprising Study-room, Library; (c) Presentation Location comprising Classroom, Conference-room; (d) Participation Location comprising Auditorium, Social-activity-location, Sports-field; (e) Practice Location comprising Auditorium, Social-activity-location, Sports-field; and (f) View Location comprising Auditorium, Social-activity-location, Sports-field. One of the reasons for introducing the notion of meta-locations is to account for variabilities and be able to abstract and identify patterns in spite of these variations. For the same reason, typical time intervals are identified.

FIG. 2D provides a typical list of time intervals. Each of these intervals subsumes a range of time points. A typical list of time intervals include (270), Year-wise, Term-wise (say, a semester), Month-wise, Week-wise, and Day-wise.

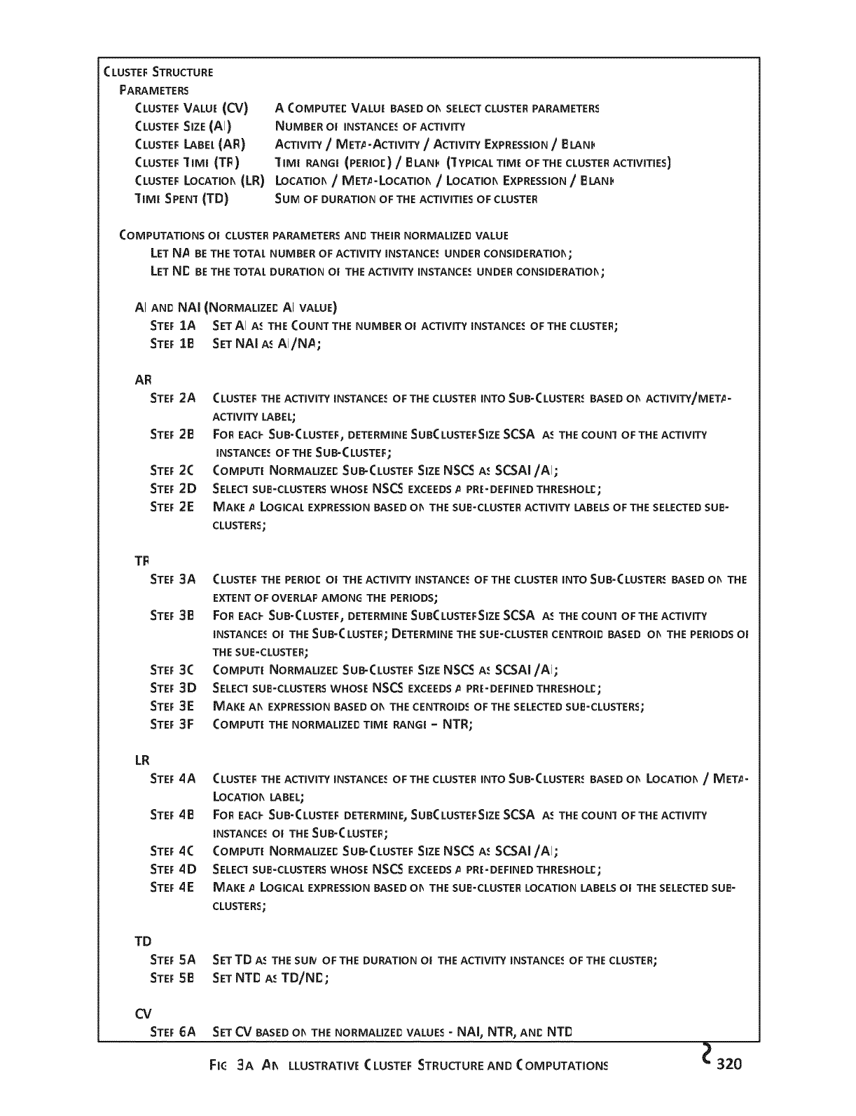

FIG. 3 depicts the various types or kinds of activity maps. Broadly, five distinct maps are defined (300): activity map (AM), temporal map (TM), location map (LM), sequence map (SM), and temporal-location-activity map (TLAM). Please note that in the following, map and cluster are used interchangeably.

An activity map provides information about the various activities over a period of time: that is, given a set of activities of a student, the activity map elaborates the activities that seem to be of interest to the student. The activities under consideration could be meta-activities as well. Hence, as depicted in the figure, there are three kinds of activity maps: AM1 related to the cluster of activities; AM2 related to the cluster of pseudo-continuous activities; and AM3 related to the cluster of meta-activities. AM2 brings out a way to discover a pattern from the seemingly unrelated activities based on their respective activity time periods.

A temporal map provides information about the various activities with respect to their similarity along the period of these activities. A year-wise temporal map identifies the prominent activities over a period of one year across several years. Similarly, a term-wise temporal map identifies the prominent activities over a period of a given term, say, half-year, a month-wise temporal map identifies the prominent activities over a period of one month across several months, a week-wise temporal map identifies the prominent activities over a period of a week across several weeks, and a day-wise temporal map identifies the prominent activities over a day across several days. Note that month-wise temporal map can also be with respect to a particular month, say, January, and day-wise temporal map can also be with respect to a particular day, say, Monday. TM1 is a temporal cluster with respect to a period of interest, say, year, term, month, week, or day.

A location map provides information about the various activities with respect to their similarity along the location or meta-location of the activities. LM1 is the cluster of activities with respect to their location similarity and LM2 is the cluster of activities with respect to their meta-location similarity.

A sequence map provides information about the various activities that correlate with respect to time and location. SM1 is the sequence of activities aligned temporally and spatially.

A temporal-location-activity map is based on a 3-dimensional clustering based on the time period and the location of the various similar activities and for visualization purposes time gets depicted along x-axis, location along y-axis, and activity along z-axis.

FIG. 3A provides an illustrative cluster structure and computations.

A cluster or map is an abstraction or summarization of a set of activities and this abstraction is described using a structure as depicted below (320):

Cluster Structure
Parameters
Cluster Value (CV): A Computed Value based on select cluster parameters
Cluster Size (AI): Number of instances of activity
Cluster Label (Activity Range—AR): Activity/Meta-Activity/Activity Expression/Blank
Cluster Time Range (TR): Time range (period)/Blank (Typical time when the cluster activities get performed)
Cluster Location Range (LR): Location/Meta-Location/Location Expression/Blank
Cluster Duration (Time Spent (TD)): Sum of duration of the activities of cluster

Each of the parameters helps characterize a map or cluster:

(a) AI indicates the number of activities that have been grouped together in the cluster under consideration and this relatively indicates how relevant this particular cluster is.
(b) AR (activity range) is a derived description (label) of the cluster and is based on the description of the activities that are a part of the cluster.
(c) TR (time range) is a derived time period of the cluster and is based on the time period of the activities of the cluster.
(d) LR (Location range) is a derived location indicating the abstracted location of the activities of the cluster.
(e) TD (Time duration) is a derived duration information and is based on the duration of the activities of the cluster.

Given a cluster of activities, how do we compute the above mentioned cluster parameters?

For this purpose, let NA be the total number of activity instances under consideration and some of these activity instances are a part of the cluster and similarly, let ND be the total duration of the activity instances under consideration.

### Steps for Computing a Normalized AI Value

### AI and NAI (Normalized AI Value):

Step 1A: Set AI as the Count the number of activity instances of the cluster;
Step 1B: Set NAI as AI/NA;

### Steps for Computing an Activity Range

### AR:

Step 2A: Cluster the activity instances of the cluster into Sub-Clusters based on activity/meta-activity label;
Step 2B: For each Sub-Cluster determine, SubClusterSize SCSAI as the count of the activity instances of the Sub-Cluster;
Step 2C: Compute Normalized Sub-Cluster Size NSCS as SCSAI/AI;
Step 2D: Select sub-clusters whose NSCS exceeds a pre-defined threshold;
Step 2E: Make a Logical expression based on the sub-cluster activity labels of the selected sub-clusters;

### Steps for Computing a Time Range

### TR:

Step 3A: Cluster the period of the activity instances of the cluster into Sub-Clusters based on the extent of overlap among the periods;
Step 3B: For each Sub-Cluster determine, SubClusterSize SCSAI as the count of the activity instances of the Sub-Cluster; Determine the sub-cluster centroid based on the periods of the sub-cluster;
Step 3C: Compute Normalized Sub-Cluster Size NSCS as SCSAI/AI;
Step 3D: Select sub-clusters whose NSCS exceeds a pre-defined threshold;
Step 3E: Make an expression based on the centroids of the selected sub-clusters;
Step 3F: Compute the normalized time range—NTR;

### Steps for Computing a Location Range

### LR:

Step 4A: Cluster the activity instances into Sub-Clusters based on Location/Meta-Location label;
Step 4B: For each Sub-Cluster determine, SubClusterSize SCSAI as the count of the activity instances of the Sub-Cluster;
Step 4C: Compute Normalized Sub-Cluster Size NSCS as SCSAI/AI;
Step 4D: Select sub-clusters whose NSCS exceeds a pre-defined threshold;
Step 4E: Make a Logical expression based on the sub-cluster location labels of the selected sub-clusters;

### Steps for Computing a Cluster Duration and Normalized Cluster Duration

### TD:

Step 5A: Set TD as the sum of the duration of the activity instances;
Step 5B: Set NTD as TD/ND;

### Steps for Computing Cluster Value

### CV:

Step 6A: Set CV based on the normalized values—NAI, NTR, and NTD.

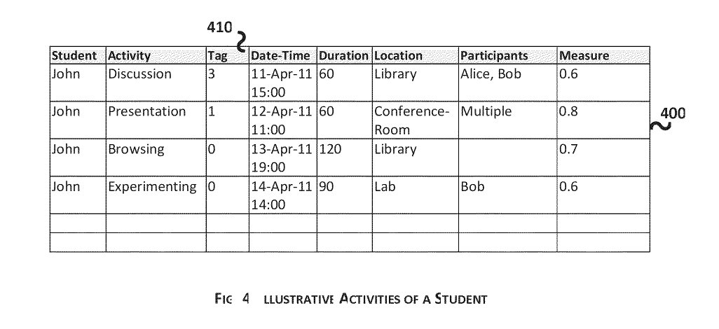

FIG. 4 provides an illustrative list of activities of a student. Note that typical activity of a student (400) is further elaborated using an attribute called Tag (410). The tag is used to indicate additional details about an activity. For example, the activity of Discussion could be related to Discussion of a topic (tag value of 0), Discussion related to solving a problem (tag value of 1), Discussion related to counseling (tag value of 2), Discussion related to clarifying a doubt (tag value of 3), and Discussion related to status (tag value of 4).

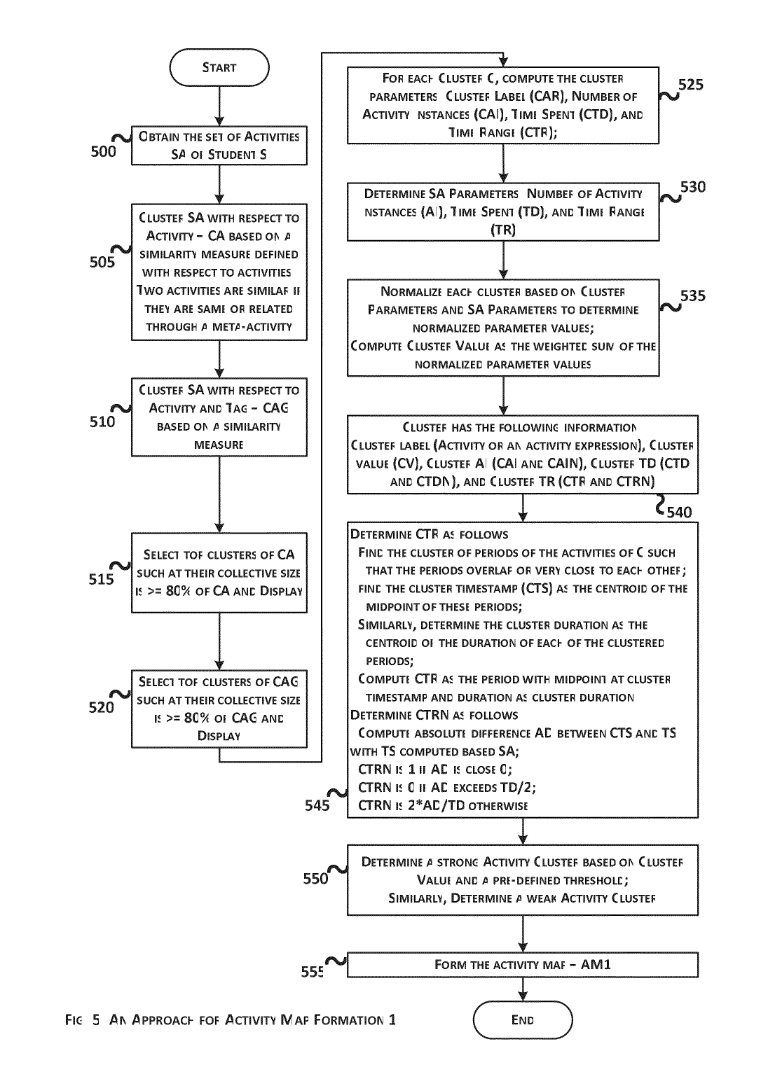

FIG. 5 provides an approach for activity map formation.

The activity map formation is based on a set of activities of a student (referred as SA). For example, this set could be the activities performed by the student over a period of time, say, one year.

Steps involved in the generation of activity map 1:
Obtain the set of Activities SA of Student S (500). The map generation is based on the process of clustering.
Cluster SA with respect to Activity to generate a set of clusters (referred as CA) based on a similarity measure defined with respect to activities: Two activities are similar if they are same or related through a meta-activity (505).
Similarly, cluster SA with respect to Activity and Tag to generate set of clusters (referred as CAG) based on a similarity measure (510). Note that CAG defines a more fine grained clusters as compared with the set of clusters CA.
Select top clusters of CA such at their collective size is greater than or equal to the 80% of CA (515).
This selection ensures that the anomalous activities are filtered out and not used to define the activity map.
Similarly, select top clusters of CAG (520).
For each Cluster C, compute the cluster parameters: Cluster Label (CAR), Cluster Size—Number of Activity Instances (CAI), Cluster Duration—Time Spent (CTD), and Time Range (CTR) (525).
Note that this and the remaining steps are repeated for each of clusters in CA and CAG. Further, the computational procedures to compute these cluster parameters are described in FIG. 3A.
Determine the SA parameters based on the activities contained in the set SA (530): Number of Activity Instances (AI), Time Spent (TD), and Time Range (TR). Note that these SA parameters are used to derived normalized cluster parameters.
Normalize each cluster based on Cluster Parameters and SA Parameters (535) to determine normalized parameter values (540). For example, CAIN can be simply CAI/AI, CTDN is equal to CTD/TD, and CTRN is equal to CTR/TR.
Compute Cluster Value as the weighted sum of the normalized parameter values.
Observe that CTR computation is based on the Steps 3A-3E. These steps can be further elaborated as follows (545):
   Find the cluster of periods of the activities of C such that the periods overlap or very close to each other;
   Find the cluster timestamp as the centroid of the midpoint of these periods;
   Similarly, determine the cluster duration as the centroid of the duration of each of the clustered periods;
   Compute CTR as the period with midpoint at cluster timestamp and duration as cluster duration;

Determine CTRN as follows:
Compute absolute difference AD between CTS and TS; Here, TS is computed based on the periods of the activities contained in SA.
CTRN is 1 if AD is close 0;
CTRN is 0 if AD exceeds TD/2;
CTRN is 2*AD/TD otherwise.

Determine a strong Activity Cluster based on Cluster Value and a pre-defined threshold (550);

Similarly, determine a weak Activity Cluster.

Form the activity map—AM1 (555).

In the least, the activity map AM1 can be based on the determined strong activity clusters. From this point of view, AM1 describes which activities (based on CAR) get performed when (based on CTR) and where (based on CLR). Further, CTD is expected to inform about the expected duration of these activities.

FIG. 5A provides an additional approach for activity map formation. The objective is to construct activity maps in as many different ways as possible so as to derive as much of distinct information of about the activities of a student. Again, the starting point is the set of activities SA of a student.

Steps involved in the generation of activity map 2:
Obtain the set of Activities SA of Student S (500A). Activity Map 2 (AM2) formation is based on a seed activity.
Obtain an Activity A of SA (505A).
Put A into Cluster C (510A).
Identify an activity Aj of SA such that Aj is similar to many one of the activities of C and the period of Aj is similar to the period of many of the activity instances of C; If so, Put Aj into C (515A).
Repeat the above step until no more activities can be put to C.
Put C into CAP—a cluster of activities based on period similarity (520A).
Form clusters in a similar manner based on the remaining activities in SA and put them into CAP.
Note that CAP is a set of clusters based on the period of the similar activities. Select top clusters of CAP such that their collective size is greater than or equal to the 80% of CAP to filter out anomalous activities (525A).
Compute the cluster parameters of each of the selected clusters (530A): Cluster label (Activity or an Activity Expression), Cluster value (CV), Cluster size AI (CAI and CAIN), Cluster duration TD (CTD and CTDN), and Cluster TR (CTR and CTRN).
Form the activity map—AM2 based on the selected clusters (535A).

Due to the role of activity periods in the cluster formation, the activities mapped by AM2 are characterized by the notion of pseudo-continuity.

The third approach to form an activity map is again based on a seed activity.

Steps involved in the generation of activity map 3:
Obtain an activity A of SA (550A).
Form a cluster C (555A).
Identify Activities Aj of SA such that the meta-activity of Aj is similar to many of the activities of C; If so, Put Aj into C (560A).
Note that this cluster formation is based on how closely the activities related from the point of view of meta-activities. Put C into CAM (565A).
Note that CAM is cluster of activities related via meta-activities. Repeat the above step until no more activities can be put into C.
Form clusters in a similar manner based on the remaining activities in SA and put them into CAM.
Select top clusters of CAM such that their collective size is greater than or equal to the 80% of CAM (570A).
Compute the cluster parameters of each of the selected clusters (575A): Cluster label (Activity or an Activity Expression), Cluster value (CV), Cluster size AI (CAI and CAIN), Cluster duration TD (CTD and CTDN), and Cluster TR (CTR and CTRN).
Form the activity map—AM3 based on the selected clusters (580A).

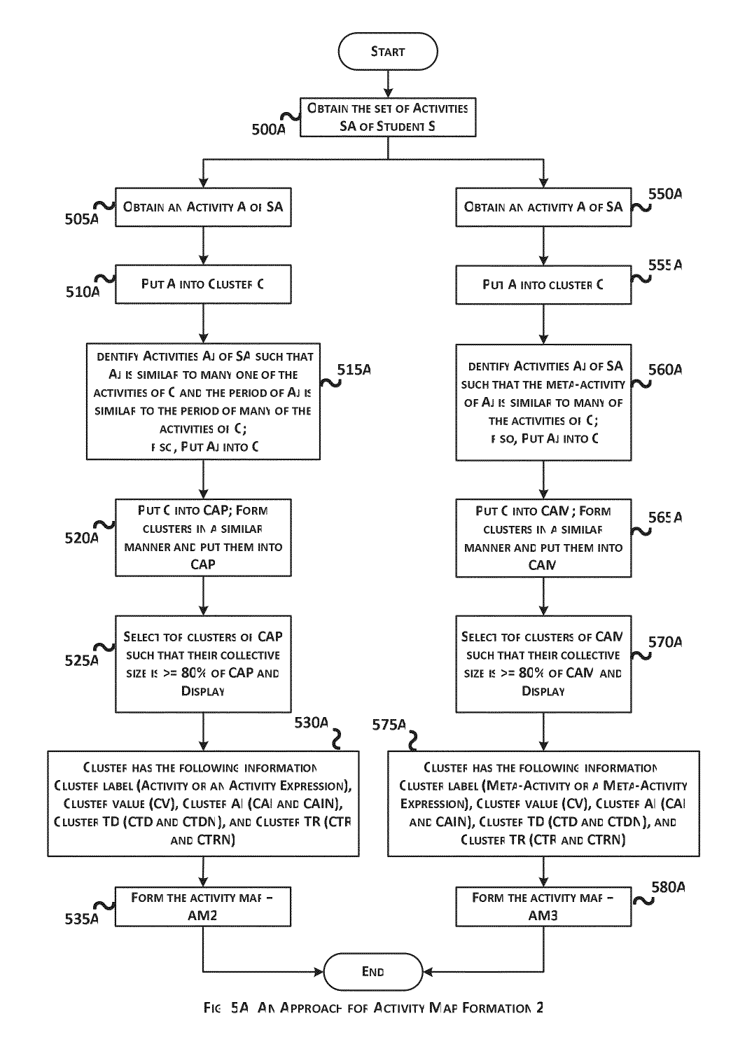

FIG. 6 depicts an approach for temporal map formation. The temporal map is based on the analysis of a set of activities of a student based on a time period of interest.

Steps involved in the generation of temporal map 1:
Obtain the set of Activities SA of Student S (600).
   Determine the time period for analysis: Year-wise, Term-Wise, Month-wise, Week-Wise, and Day-wise (605).
   Determine the set of time-specific activities TSA based on SA (610). That is, TSA comprises of the activities of SA that are within the chosen time period.
   Determine an activity A of TSA and make A part of C (615).
   Find next activity Aj of TSA such that the period of Aj is similar to the period of many of the activities of C; If so, make Aj part of C (620).
   Repeat this step until no more activities can be added to C.
   Put C into CAT (625). Note that CAT is a set of clusters of activities that are similar from temporal point of view.
   Form clusters in a similar manner based on the remaining activities of TSA and put them into CAT.
   Select top clusters of CAT such that their collective size is greater than or equal to the 80% of CAT (630) so as to filter out anomalous activities.
   Compute the cluster parameters of each of the selected clusters (635): Cluster label (a temporal expression), Cluster value (CV), Cluster size AI (CAI and CAIN), Cluster duration TD (CTD and CTDN), and Cluster activity range AR (CAR). Note that the cluster label is a temporal expression and a way to determine the same is as follows (640):
   Cluster label (Period) is determined based on the clustering of the period of the activities;
   Cluster AR (activity range) is determined by clustering the activities, determining the top clusters TC such that their collective size is about 80% of C; and forming of the activity expression based on TC.
Form the activity map—TM1 based on the selected clusters (645).

Note that based on the chosen time period, TM1 provides information about the typical activities performed by the student during that period.

FIG. 7 depicts an approach for location and sequence maps formation. A location map based on a set of activities of a student provides information about the typical location of typical activities.

Steps involved in the generation of location map 1:
Obtain the set of Activities SA of Student S (700).
Obtain an activity A of SA and determine its location L; Alternatively, L is provided as input and find A based on L;
Make A part of C (705).
Find next activity Aj from SA such that the location of Aj is similar to the location of many of the activities of C (710). If so, put Aj into C.
Repeat this step until no more activities can be added to C. Make C a part of CAL (715).
Note that CAL is a set of clusters of activities that are location specific.
Determine more such clusters based on the activities remaining in SA.
Select top clusters of CAL such that their collective size is greater than the 80% of CAL so as to filter out anomalous activities (720).
Cluster has the following information (725): Cluster label (Location or Location Expression), Cluster value (CV), Cluster size AI (CAI and CAIN), Cluster activity range AR (Activity Expression), Cluster duration TD (CTD and CTDN), and Cluster time rnage TR (CTR and CTRN). Note that the cluster label in this case is a location expression denoting the typical location of the activities contained in the cluster.
Form the spatial map—LM1 based on the selected clusters (730).
Note that LM1 can be the set of selected clusters.
Also, form LM2 wherein LM2 is based on a meta-location.

The steps involved in the determination of activity sequences that are aligned with respect to time and location are provided below.

Steps involved in the generation of sequence map 1:
Determine timestamp T of A and make A a part of sub-sequence SS (750).
Find Aj from SA such that the timestamp of Aj is similar to the timestamp of the most recent activity Ak of SS and location of Aj is similar to the location of Ak (755). If so, Put Aj into SS.
Determine all possible sub-sequences SSj (760).
Determine the Longest, Average, and Shortest sub-sequences based on the number of activities contained the sub-sequences (765).
Make them as sequence maps SM1 (770). Note that the sequence maps can be good focus indicators.

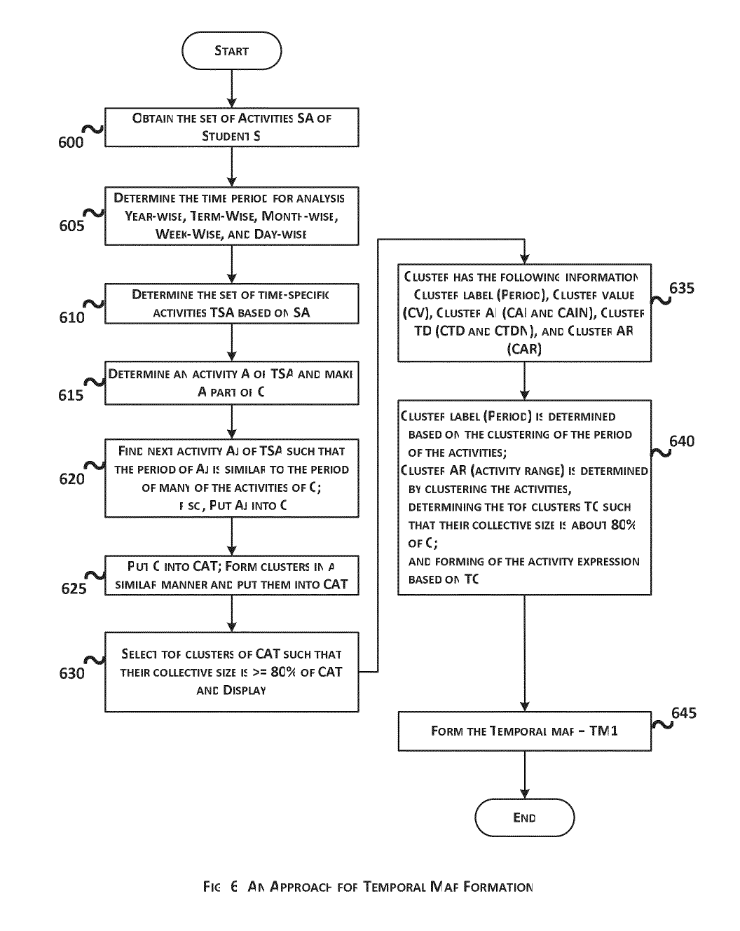

FIG. 8 provides an approach for temporal location activity map formation. The temporal location activity map (TLAM) provides the description of activities that are relevant from both time and location points of view.

Steps involved in the generation of temporal location activity map:
Obtain the set of Activities SA of Student S (800).
The 3 dimensional (3-D) clustering to generate TLAM based on SA is performed as follows (805).
Time and Location are 2-Dimensions: From the visualization point of view, Time gets displayed along X-Axis and Location along Y-Axis while visualizing the TLAM (810).
Similarity along Time is defined based on time difference based on respective timestamps and similarity along location is defined based on Location Similarity Matrix (815). For example, Location
Similarity Matrix can be based on a location hierarchy using the notion of meta-locations.
Similarity Function SF is defined as weighted function of activity similarity measure, temporal similarity measure, and spatial similarity measure (820).
Obtain an activity A of SA and make A part of C (825).
Find next activity Aj from SA such that Aj is similar based on SF with most of the activities of C (830).
If so, Put Aj into C.
Repeat this step until no more activities of SA can be made part of C. Make C part of CTLA (835).
Note that CTLA is a set of clusters of activities that are similar along time, location, and activity dimensions. Similarly form other clusters of CTLA based on remaining activities in SA.
Select top clusters of CTLA such that their collective size is greater than the 80% of CTLA (840).
Cluster C of CTLA has the following information (845): Cluster label (Activity, Meta-Activity, or Activity Expression), Cluster value (CV), Cluster size AI (CAI and CAIN), Cluster duration TD (CTD and CTDN), Cluster time range TR (CTR and CTRN), and Cluster location range LR (Location, Meta-Location, or Location Expression) (CLR).
Form TLAM based on the selected top clusters (850).

FIG. 8A provides an illustrative location similarity matrix. Note that such a similarity matrix (875) can be defined in multiple ways: for example, it could be based on nearness factor or based on the nature of location (such as places for discussion).

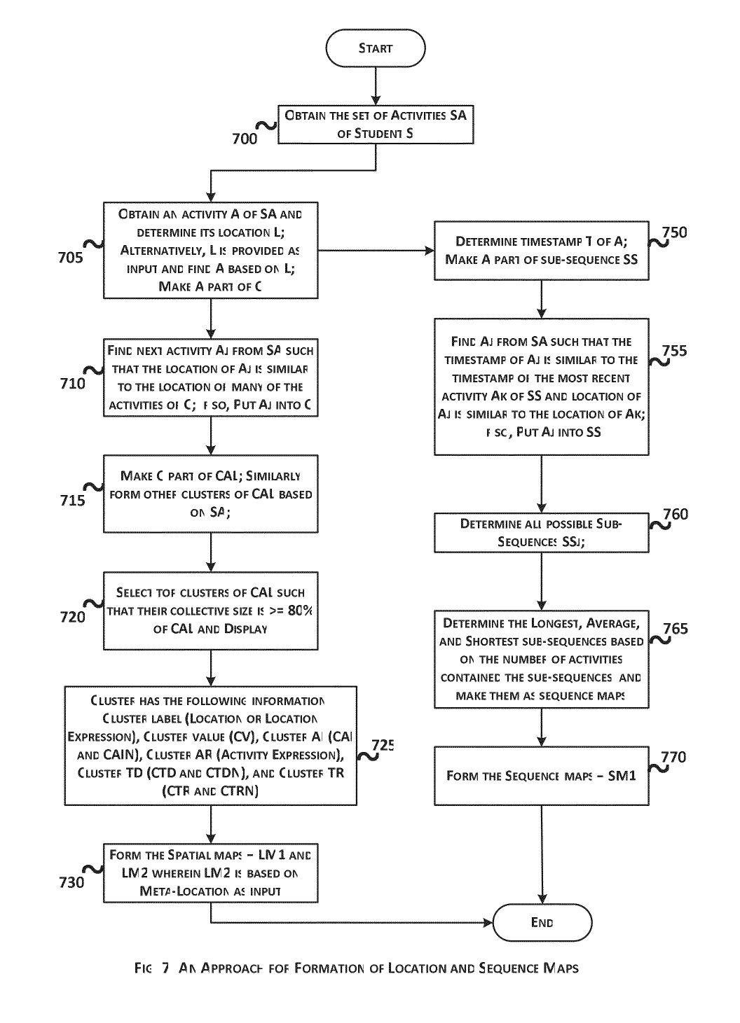

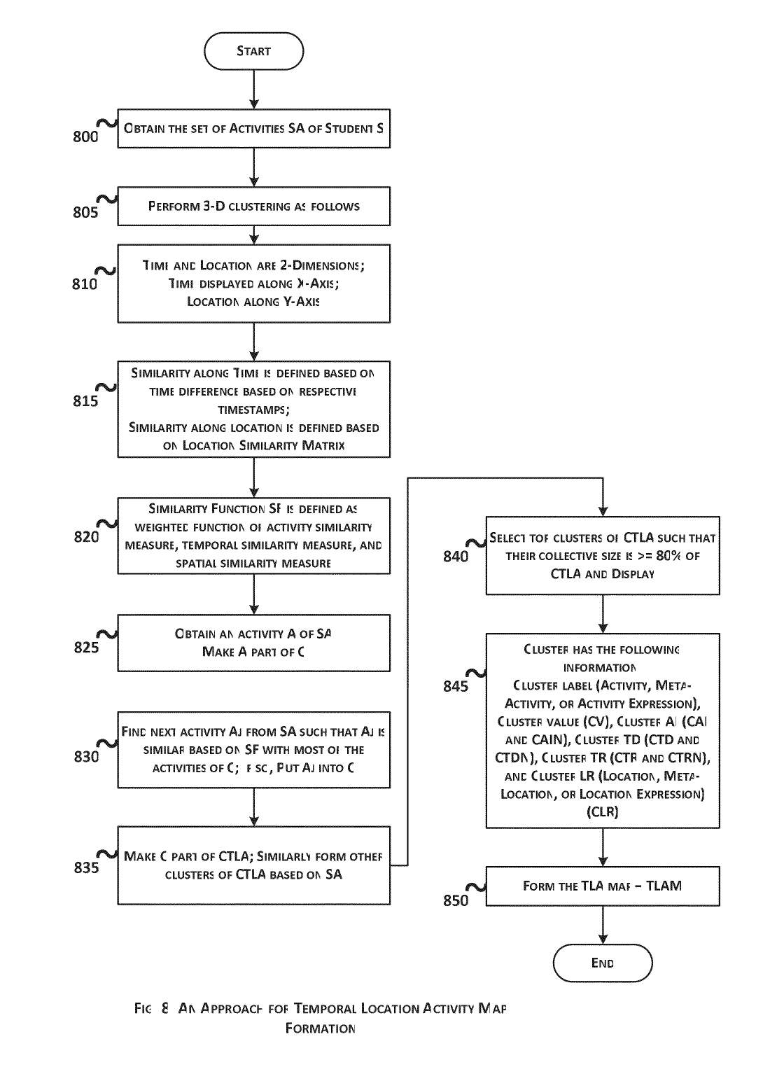

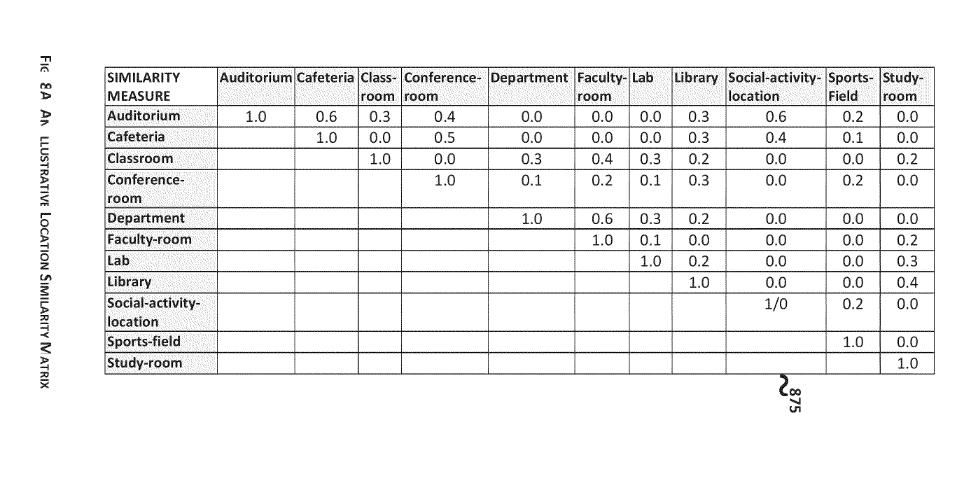

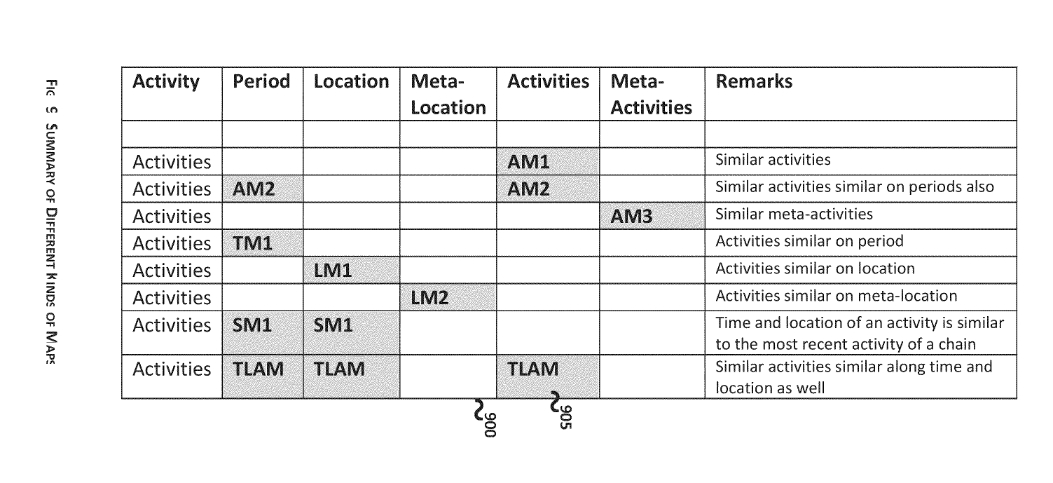

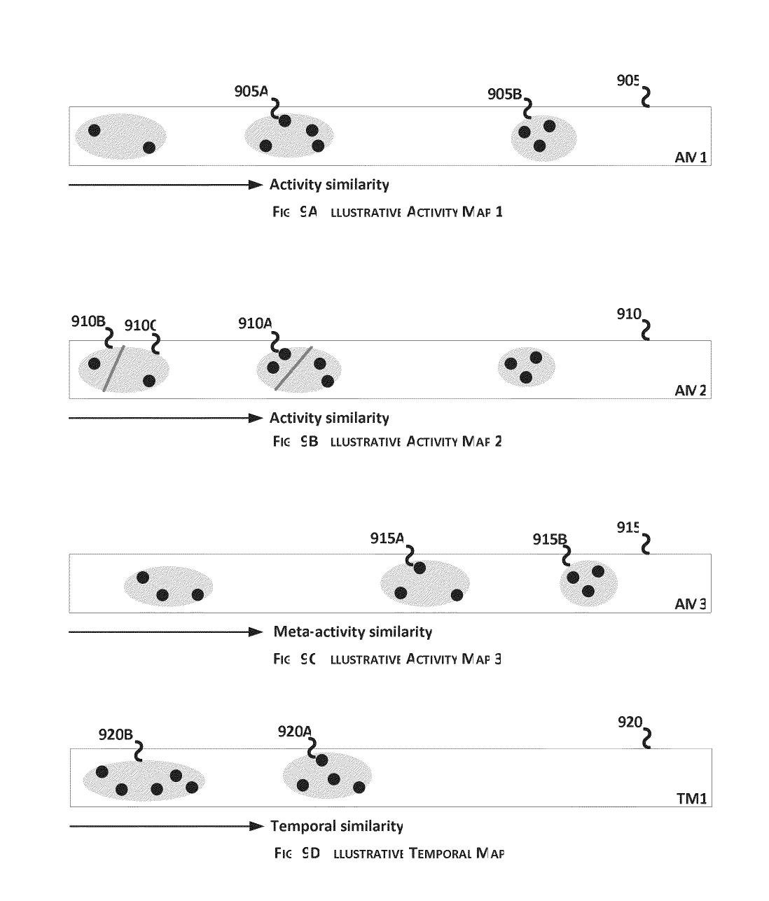

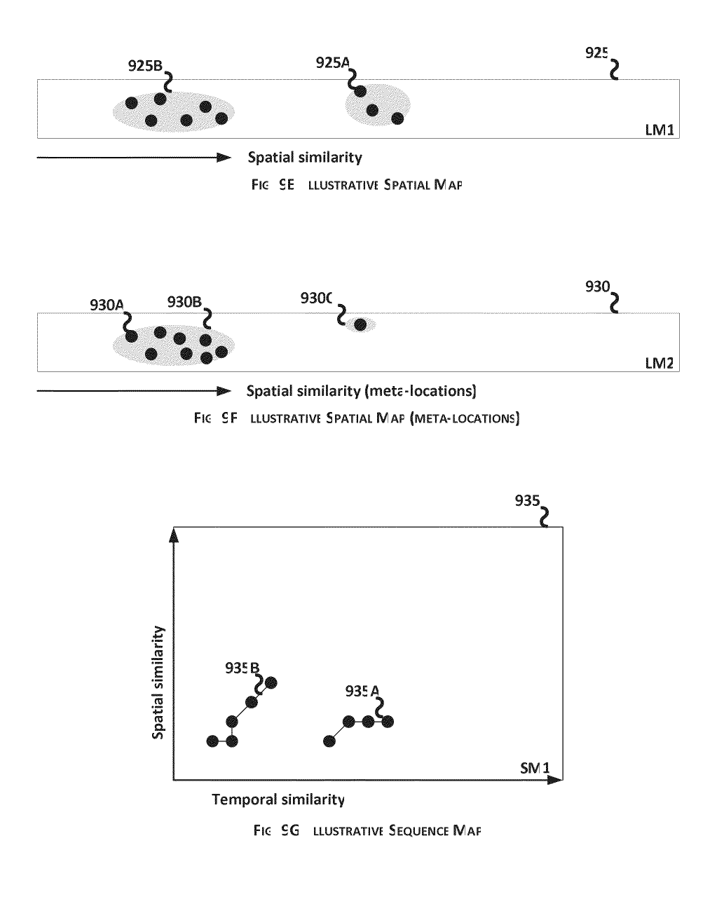

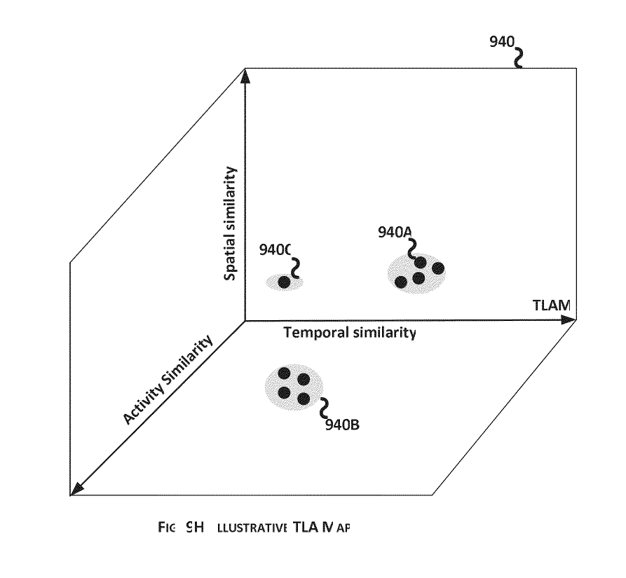

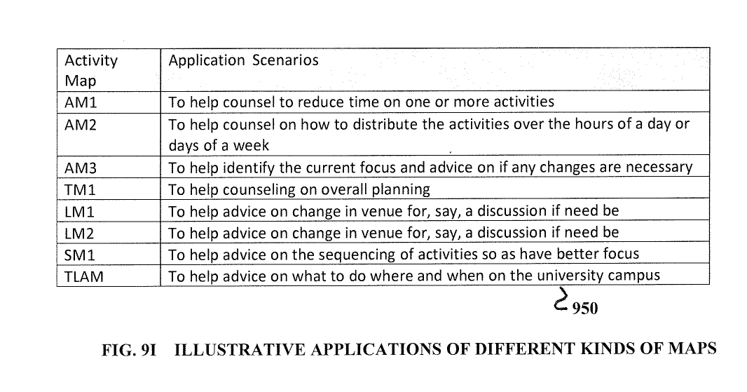

FIG. 9 provides a summary of different kinds of maps. Refer to 900. The highlighted portions (905) indicate the activity attributes that are used in the respective map formation.

FIGS. 9A-9H provide different kinds of illustrative maps.

905 depicts an activity map AM1, 910 depicts an activity map AM2, and 915 depicts an activity map AM3.

905A, 910A, and 915A show an activity and 905B, 910B, 910C, and 915B depicts illustrative clusters that are part of the respective maps (refer to FIGS. 9A, 9B, and 9C).

920 depicts a temporal map TM1 with 920A showing an activity and 920B a cluster part of TM1 (refer to FIG. 9D).

925 depicts a spatial map LM1 with 925A showing an activity and 925B a cluster part of LM1 (refer to FIG. 9E).

930 depicts a spatial map LM2 with 930A showing an activity and 930B a cluster part of LM2 (refer to FIG. 9F). Note the singleton cluster 930C is not a part of LM2.

935 depicts a sequence map SM1 with 935A showing an activity and 935B a sub-sequence part of SM1 (refer to FIG. 9G).

940 depicts a TLA map TLAM with 940A showing an activity and 940B a cluster part of TLAM (refer to FIG. 9H). Note the singleton cluster 940C is not a part of TLAM.

FIG. 9I provides illustrative application scenarios of the different kinds of maps. These applications scenarios bring out the utility of the generated maps in the context of a university (950). For example,
AM1 can be used to help counsel to reduce time on one or more activities;
AM2 can be used to help counsel on how to distribute the activities over the hours of a day or days of a week;
AM3 can be used to help identify the current focus and advice on if any changes are necessary;
TM1 can be used to help counseling on overall planning;
LM1 can be used to help advice on change in venue for, say, a discussion if need be;
LM2 can be used to help advice on change in venue for, say, a discussion if need be;
SM1 can be used to help advice on the sequencing of activities so as have better focus; and
TLAM can be used to help advice on what to do where and when on the university campus.

Thus, a system and method for determining of student activity maps in the context of a university is disclosed. Although the present invention has been described particularly with reference to the figures, it will be apparent to one of the ordinary skill in the art that the present invention may appear in any number of systems that provide for discovering patterns in a set of activities. It is further contemplated that many changes and modifications may be made by one of ordinary skill in the art without departing from the spirit and scope of the present invention.

We claim:

1. A computer implemented method for the generation of a plurality of activity maps of a student of a university based on a plurality of activities of said student with respect to said university, a plurality of meta-activities, a plurality of locations, a plurality of meta-locations, and a plurality of time intervals,
the method performed on a computer system comprising at least one processor,
said method comprising the steps of:
generating, with at least one processor, an activity map 1 based on said plurality of activities;
making, with at least one processor, said activity map 1 a part of said plurality of activity maps;
generating, with at least one processor, an activity map 2 based on said plurality of activities;
making, with at least one processor, said activity map 2 a part of said plurality of activity maps;
generating, with at least one processor, an activity map 3 based on said plurality of activities;
making, with at least one processor, said activity map 3 a part of said plurality of activity maps;
generating, with at least one processor, a temporal map 1 based on said plurality of time intervals and said plurality of activities;
making, with at least one processor, said temporal map 1 a part of said plurality of activity maps;
generating, with at least one processor, a location map 1 based on said plurality of locations and said plurality of activities;
making, with at least one processor, said location map 1 a part of said plurality of activity maps;
generating, with at least one processor, a location map 2 based on said plurality of meta-locations and said plurality of activities;
making, with at least one processor, said location map 2 a part of said plurality of activity maps;
generating, with at least one processor, a sequence map 1 based on said plurality of locations and said plurality of activities;
making, with at least one processor, said sequence map 1 a part of said plurality of activity maps;
generating, with at least one processor, a temporal location activity map based on said plurality of locations and said plurality of activities; and
making, with at least one processor, said temporal location activity map a part of said plurality of activity maps.

2. The method of claim 1, wherein said step for generating said activity map 1 further comprises the steps of:
clustering said plurality of activities to result in a plurality of clusters, wherein an activity of a cluster of said plurality of clusters is similar to an activity 1 of said cluster based on a similarity measure defined with respect to said plurality of activities;
clustering said plurality of activities to result in a plurality of tag clusters, wherein an activity of a tag cluster of said plurality of tag clusters is similar to an activity 1 of said tag cluster based on a similarity measure defined with respect to said plurality of activities and a plurality of tags associated with said plurality of activities;
selecting a plurality of top clusters of said plurality of clusters, wherein the ratio of a size of said plurality of top clusters and a size of said plurality of clusters exceeds a pre-defined threshold;
determining a top cluster of said plurality of top clusters;
computing a cluster size of said top cluster based on a number of activities of said top cluster;
computing a cluster activity range of said top cluster;
assigning said cluster activity range as label of said top cluster;
computing a cluster time range of said top cluster;
computing a cluster time duration of said top cluster based on a plurality of durations associated with a plurality of top cluster activities of said top cluster;
computing a cluster value of said top cluster; and
constructing said activity map 1 based on said plurality of top clusters.

3. The method of claim 2, wherein said step for computing said cluster activity range further comprises the steps of:
clustering a plurality of top cluster activities of said top cluster to result in a plurality of sub-clusters;
computing a sub-cluster size of a sub-cluster of said plurality of sub-clusters based on a plurality of sub-cluster activities of said sub-cluster;
computing a normalized size of a plurality of normalized sizes of said sub-cluster based on said sub-cluster size and said top cluster size;
selecting a plurality of selected sub-clusters based on said plurality of sub-clusters and said plurality of normalized sizes; and
making said cluster activity range based on a plurality of labels associated with said plurality of selected sub-clusters.

4. The method of claim 2, wherein said step for computing said cluster time range further comprises the steps of:
clustering a plurality of time periods associated with a plurality of top cluster activities of said top cluster resulting in a plurality of clustered time periods;
computing a cluster time stamp based on said plurality of clustered time periods;
computing a cluster duration based on a plurality of durations associated with said plurality of clustered time periods; and
computing said cluster time range based on said cluster time stamp and said cluster duration.

5. The method of claim 2, wherein said step for computing said cluster value further comprises the steps of:
computing a normalized cluster size based on said cluster size of said top cluster and said plurality of activities;
computing a normalized cluster time range based on said cluster time range and a plurality of activity periods associated with said plurality of activities;
computing a normalized cluster time duration based on said cluster duration and a plurality of activity durations associated with said plurality of activities; and
computing said cluster value based on said normalized cluster size, said a normalized cluster time range, and said normalized cluster time duration.

6. The method of claim 1, wherein said step for generating said activity map 2 further comprises the steps of:
determining an activity of said plurality of activities;
making said activity a part of a cluster;
determining an activity 1 of said plurality of activities, wherein said activity 1 is similar to many of the activities in said cluster and a period of said activity 1 is similar to many of the activities of said cluster;
making said cluster a part of a plurality of activity period clusters;
selecting a plurality of top clusters based on said plurality of activity period clusters, wherein the ratio of a size of said plurality of top clusters and a size of said plurality of activity period clusters exceeds a pre-defined threshold;
determining a top cluster of said plurality of top clusters;
computing a cluster size of said top cluster based on a number of top cluster activities of said top cluster;
computing a cluster activity range of said top cluster;
assigning said cluster activity range as label of said top cluster;
computing a cluster time range of said top cluster;
computing a cluster time duration of said top cluster based on a plurality of durations associated with a plurality of top cluster activities of said top cluster;
computing a cluster value of said top cluster; and
constructing said activity map 2 based on said plurality of top clusters.

7. The method of claim 1, wherein said step for generating said activity map 3 further comprises the steps of:
determining an activity of said plurality of activities;
making said activity a part of a cluster;
determining of an activity 1 of said plurality of activities, wherein a meta-activity of said activity 1 is similar to many of the activities in said cluster;
making said cluster a part of a plurality of meta-activity clusters;
selecting a plurality of top clusters based on said plurality of meta-activity clusters, wherein the ratio of a size of said plurality of top clusters and a size of said plurality of meta-activity clusters exceeds a pre-defined threshold;
determining a top cluster of said plurality of top clusters;
computing a cluster size of said top cluster based on a number of top cluster activities of said top cluster;
computing a cluster activity range of said top cluster;
assigning said cluster activity range as label of said top cluster;
computing a cluster time range of said top cluster;
computing a cluster time duration of said top cluster based on a plurality of durations associated with a plurality of top cluster activities of said top cluster;
computing a cluster value of said top cluster; and
constructing said activity map 3 based on said plurality of top clusters.

8. The method of claim 1, wherein said step for generating said temporal map 1 further comprises the steps of:
determining a time interval based on said plurality of time intervals;
determining a set of time specific activities based on said plurality of activities and said time interval;
determining an activity of said plurality of time specific activities;
making said activity a part of a cluster;
determining of an activity 1 of said plurality of time specific activities, wherein a period of said activity 1 is similar to many of the activities in said cluster;
making said cluster a part of a plurality of time period clusters;
selecting a plurality of top clusters based on said plurality of time period clusters, wherein the ratio of a size of said plurality of top clusters and a size of said plurality of time period clusters exceeds a pre-defined threshold;
determining a top cluster of said plurality of top clusters;
computing a cluster size of said top cluster based on a number of top cluster activities of said top cluster;
computing a cluster activity range of said top cluster;
computing a cluster time range of said top cluster;
assigning said cluster time range as label of said top cluster;
computing a cluster time duration of said top cluster based on a plurality of durations associated with a plurality of top cluster activities of said top cluster;
computing a cluster value of said top cluster; and
constructing said temporal map 1 based on said plurality of top clusters.

9. The method of claim 1, wherein said step for generating said location map 1 further comprises the steps of:
determining an activity of said plurality of activities;
determining a location of said activity;
making said activity a part of a cluster;
determining of an activity 1 of said plurality of activities, wherein a location of said activity 1 is similar to the location of many of the activities in said cluster;
making said cluster a part of a plurality of location clusters;
selecting a plurality of top clusters based on said plurality of location clusters, wherein the ratio of a size of said plurality of top clusters and a size of said plurality of location clusters exceeds a pre-defined threshold;
determining a top cluster of said plurality of top clusters;
computing a cluster size of said top cluster based on a number of top cluster activities of said top cluster;
computing a cluster activity range of said top cluster;
computing a cluster location range of said top cluster;
assigning said cluster location range as label of said top cluster;
computing a cluster time range of said top cluster;
computing a cluster time duration of said top cluster based on a plurality of durations associated with a plurality of top cluster activities of said top cluster;
computing a cluster value of said top cluster; and
constructing said location map 1 based on said plurality of top clusters.

10. The method of claim 9, wherein said step for determining said activity further comprises the steps of:
determining a location based on said plurality of locations; and
determining said activity based on said plurality of activities and said location.

11. The method of claim 1, wherein said step for generating said sequence map 1 further comprises the steps of:
determining an activity of said plurality of activities;
making said activity a part of a sub-sequence;
determining a most recent activity of said sub-sequence;
determining of an activity 1 of said plurality of activities, wherein a time period of said activity 1 is similar to the time period of said most recent activity and a location of said activity 1 is similar to the location of said most recent activity;
making of said activity a part of said sub-sequence;
making said sub-sequence a part of a plurality of sub-sequences;
determining a longest sub-sequence based on said plurality of sub-sequences;
determining an average sub-sequence based on said plurality of sub-sequences;
determining a shortest sub-sequence based on said plurality of sub-sequences; and
constructing said sequence map 1 based on said longest sub-sequence, said average sub-sequence, said shortest sub-sequence, and said plurality of sub-sequences.

12. The method of claim 1, wherein said step for generating said temporal location activity map further comprises the steps of:
determining an activity of said plurality of activities;
making said activity a part of a cluster;
determining of an activity 1 of said plurality of activities, wherein said activity 1 is similar to many of the activities in said cluster based on a similarity function, wherein said similarity function is based on an activity similarity measure, a temporal similarity measure, and a spatial similarity measure;
making said cluster a part of a plurality of time location activity clusters;
selecting a plurality of top clusters based on said plurality of time location activity clusters, wherein the ratio of a size of said plurality of top clusters and a size of said plurality of time location activity clusters exceeds a pre-defined threshold;
determining a top cluster of said plurality of top clusters;
computing a cluster size of said top cluster based on a number of top cluster activities of said top cluster;
computing a cluster activity range of said top cluster;
assigning said cluster activity range as label of said top cluster;
computing a cluster time range of said top cluster;
computing a cluster location range of said top cluster;
computing a cluster time duration of said top cluster based on a plurality of durations associated with a plurality of top cluster activities of said top cluster;
computing a cluster value of said top cluster; and
constructing said temporal location activity map based on said plurality of top clusters.
